(19) United States
(12) Patent Application Publication
(10) Pub. No.: US 2025/0187436 A1
(43) Pub. Date: Jun. 12, 2025

(54) VEHICLE DISPLAY DEVICE

(71) Applicant: YAZAKI CORPORATION, Tokyo (JP)

(72) Inventors: Takenobu Tomihira, Susono-shi (JP); Sosuke Yamamoto, Makinohara-shi (JP); Yoshiharu Matsuo, Makinohara-shi (JP)

(21) Appl. No.: 18/961,347

(22) Filed: Nov. 26, 2024

(30) Foreign Application Priority Data
Dec. 8, 2023 (JP) 2023-207949

(51) Int. Cl. B60K 35/28; B60K 35/80

(52) U.S. Cl. CPC B60K 35/28; B60K 35/80; B60K 2360/176; B60K 2360/785

(57) ABSTRACT

A vehicle display device includes a display device configured to display an image to a driver of a vehicle, and a control unit configured to control the display device, in which an image to be displayed by the display device includes a first image and a second image, and the first image is an image simulating a scenery of a front side of the vehicle, and is an image in which a depth that is based on a first vanishing point is represented, and the second image is an image for information provision that is to be displayed in a same region as a display region of the first image, and is an image in which a depth that is based on a vanishing point different from the first vanishing point is represented.

### CROSS-REFERENCE TO RELATED APPLICATION(S)

The present application claims priority to and incorporates by reference the entire contents of Japanese Patent Application No. 2023-207949 filed in Japan on Dec. 8, 2023.

### BACKGROUND OF THE INVENTION

### 1. Field of the Invention

The present invention relates to a vehicle display device.

### 2. Description of the Related Art

There has been conventionally a device that displays an image such as a virtual image. Japanese Patent Application Laid-open No. 2023-056063 discloses a vehicle display device that includes a first display emitting first display light and a second display emitting second display light, and displays a virtual image by projecting the first display light and the second display light onto a windshield.

In a case where an image with a sense of depth is displayed by a vehicle display device, it is desirable that a degradation in visibility of the image can be suppressed. For example, in a case where an image is displayed on the rear side in a depth direction, the visibility sometimes deteriorates by the size of the image getting smaller. For example, in the case of representing a sense of depth in an image, the visibility sometimes deteriorates by an interval between a plurality of contents being narrowed.

### SUMMARY OF THE INVENTION

The object of the present invention is to provide a vehicle display device that can display an image with a sense of depth while suppressing a degradation in visibility.

In order to achieve the above mentioned object, a vehicle display device according to one aspect of the present invention includes a display device configured to display an image to a driver of a vehicle; and a control unit configured to control the display device, wherein an image to be displayed by the display device includes a first image and a second image, wherein the first image is an image simulating a scenery of a front side of the vehicle, and is an image in which a depth that is based on a first vanishing point is represented, and wherein the second image is an image for information provision that is to be displayed in a same region as a display region of the first image, and is an image in which a depth that is based on a vanishing point different from the first vanishing point is represented.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of a vehicle equipped with a vehicle display device of an embodiment;

FIG. 2 is a configuration diagram of a vehicle display device according to an embodiment;

FIG. 3 is a diagram illustrating a first image and a second image according to an embodiment;

FIG. 4 is a diagram illustrating a size of an image that is based on a first vanishing point;

FIG. 5 is a diagram illustrating a scenery of a front side of a vehicle and a virtual image;

FIG. 6 is a diagram illustrating an example of a first image and a second image;

FIG. 7 is a diagram illustrating an example of a first image and a second image;

FIG. 8 is a diagram illustrating a scenery of a front side of a vehicle and a virtual image;

FIG. 9 is a diagram illustrating another example of a first image and a second image;

FIG. 10 is a diagram illustrating another example of a first image and a second image;

FIG. 11 is a diagram illustrating another example of a first image and a second image;

FIG. 12 is a diagram illustrating a content image to be displayed together with a guide image;

FIG. 13 is a diagram illustrating an example of a third vanishing point; and

FIG. 14 is a diagram illustrating a virtual image to be displayed with inclination.

### DETAILED DESCRIPTION OF THE PREFERRED EMBODIMENTS

Hereinafter, a vehicle display device according to an embodiment of the present invention will be described in detail with reference to the drawings. In addition, the present invention is not limited by the embodiment. In addition, components in the following embodiment include the ones easily-conceived by those skilled in the art, or the ones that are substantially identical.

### Embodiment

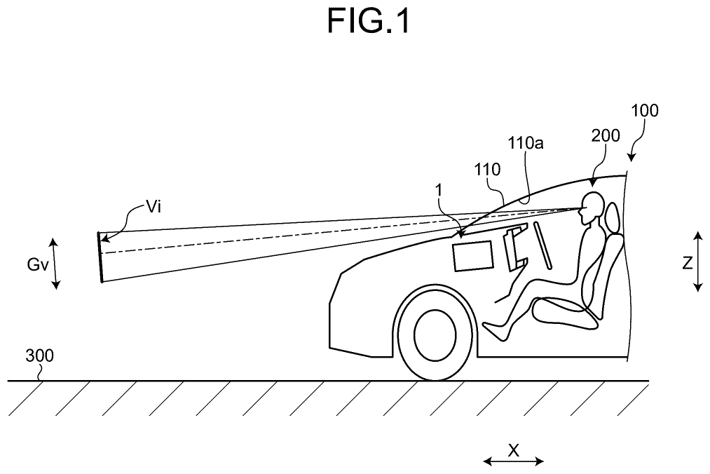

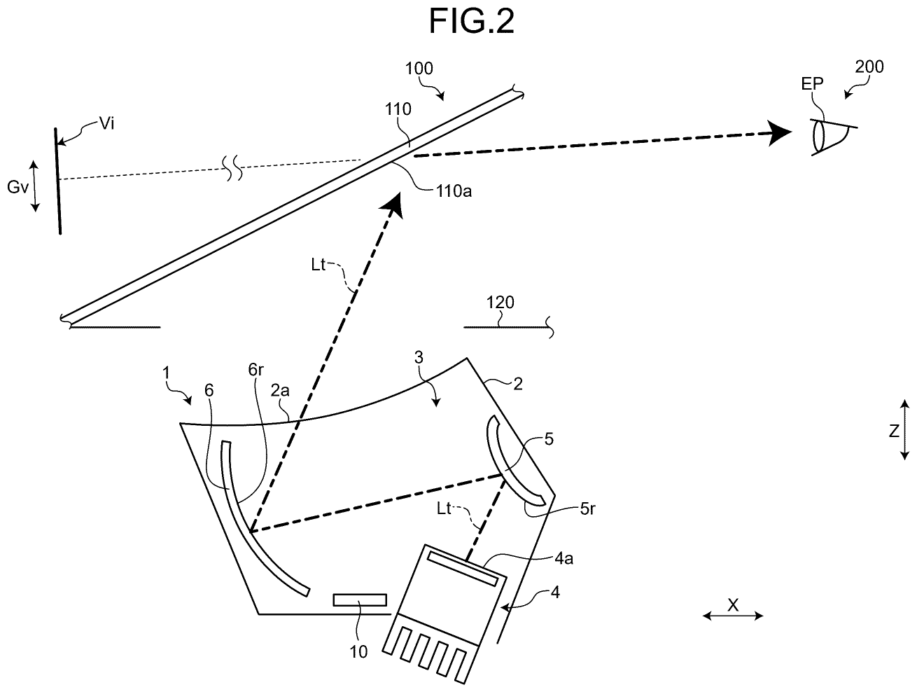

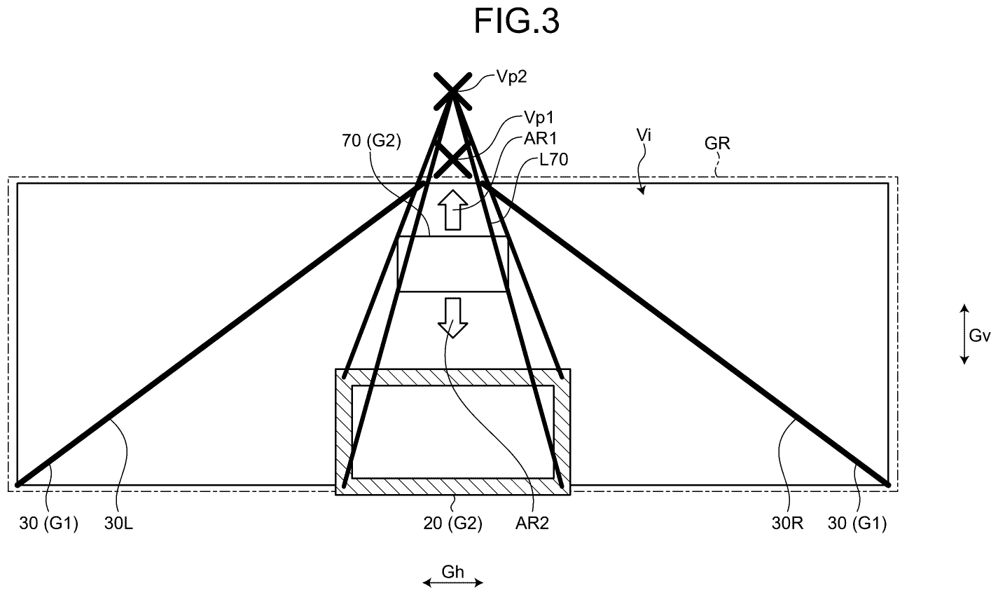

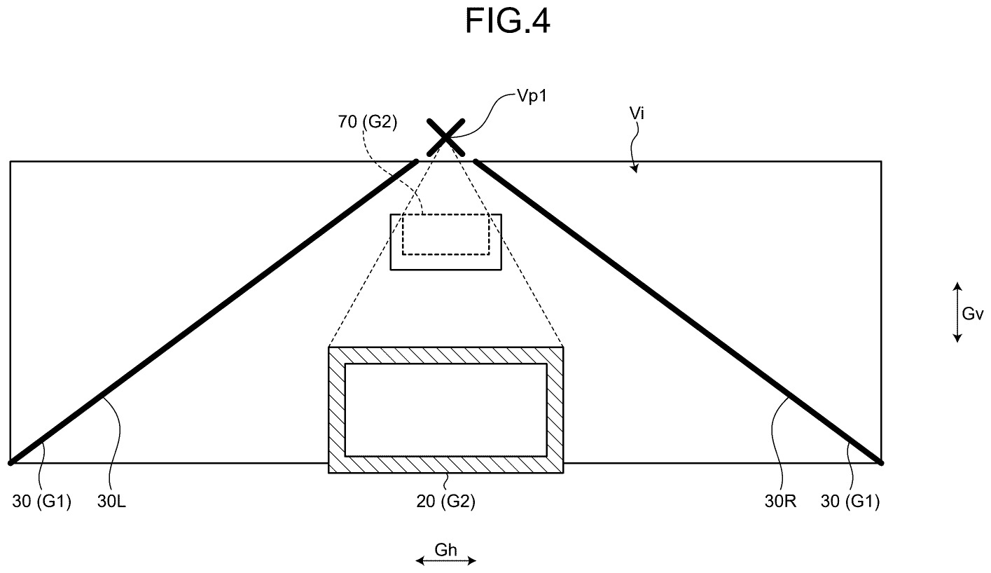

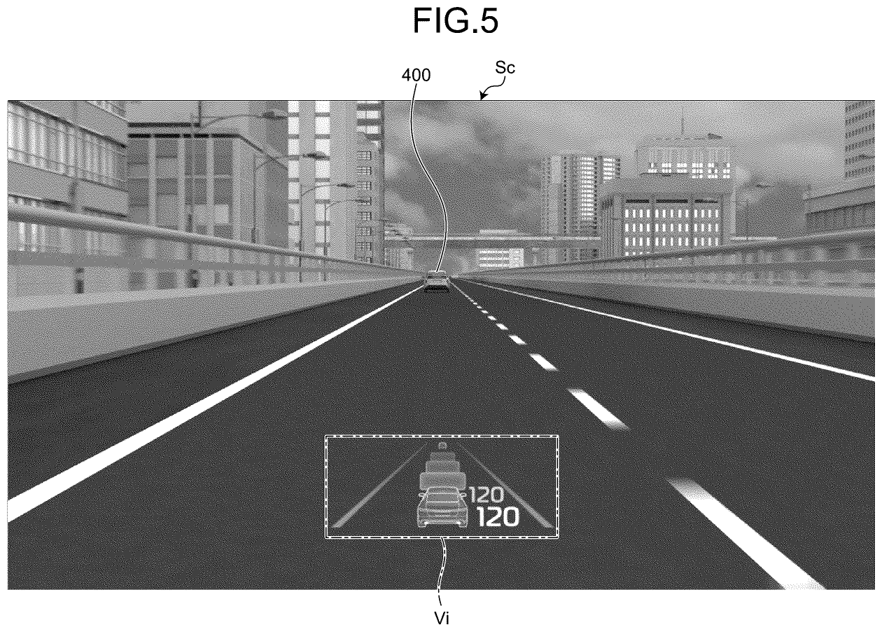

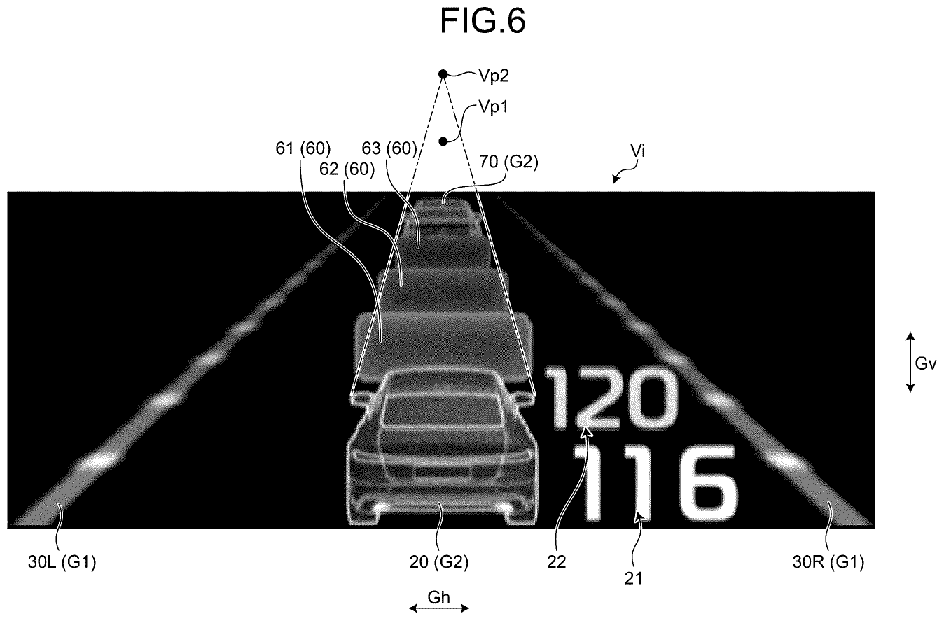

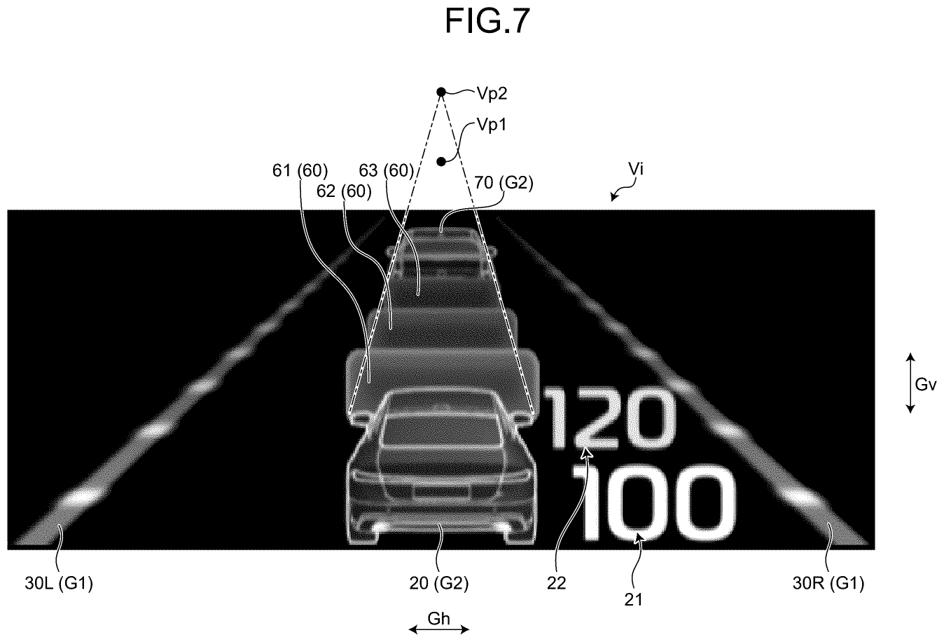

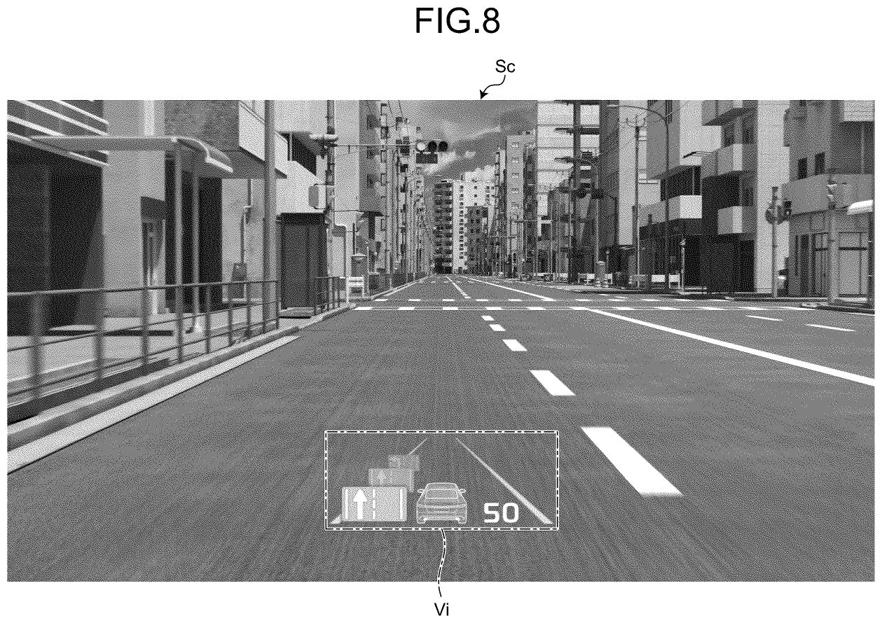

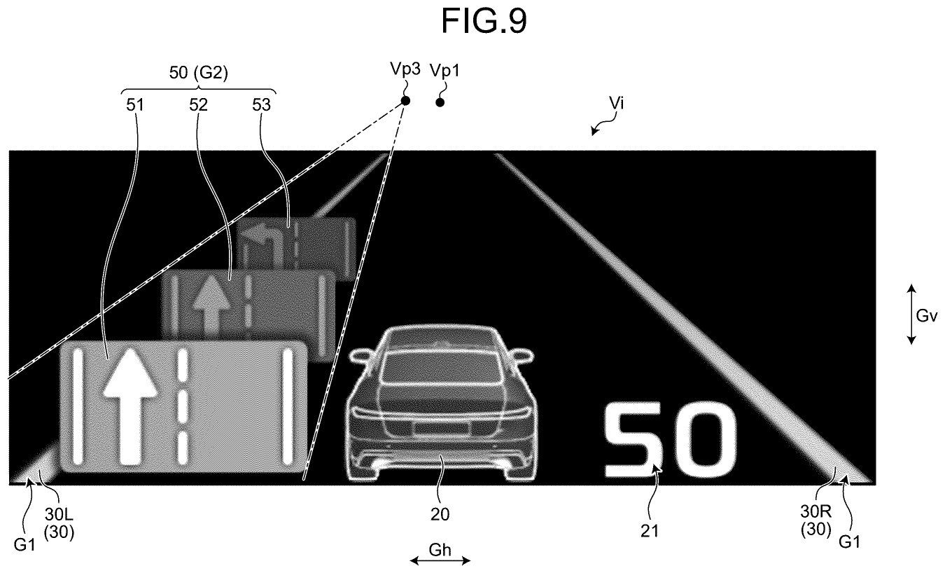

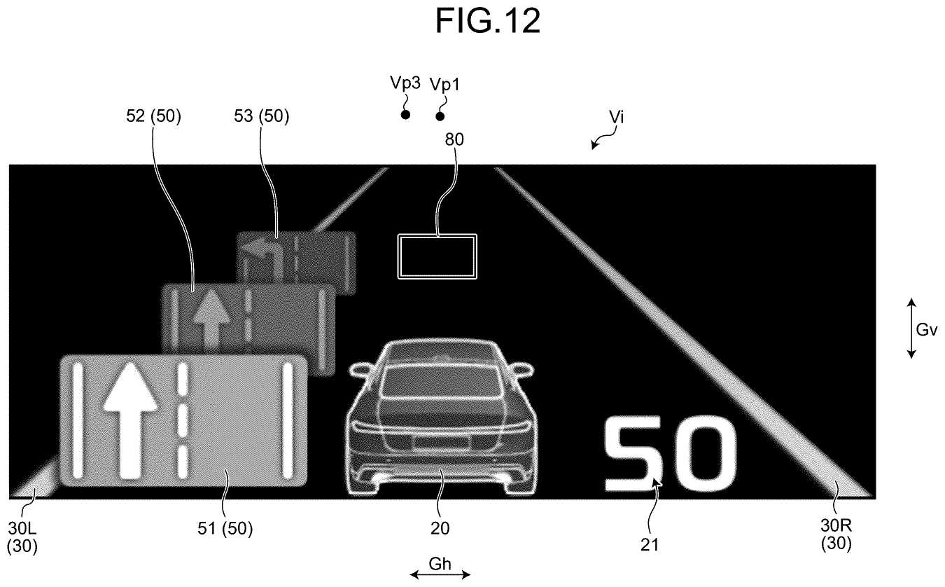

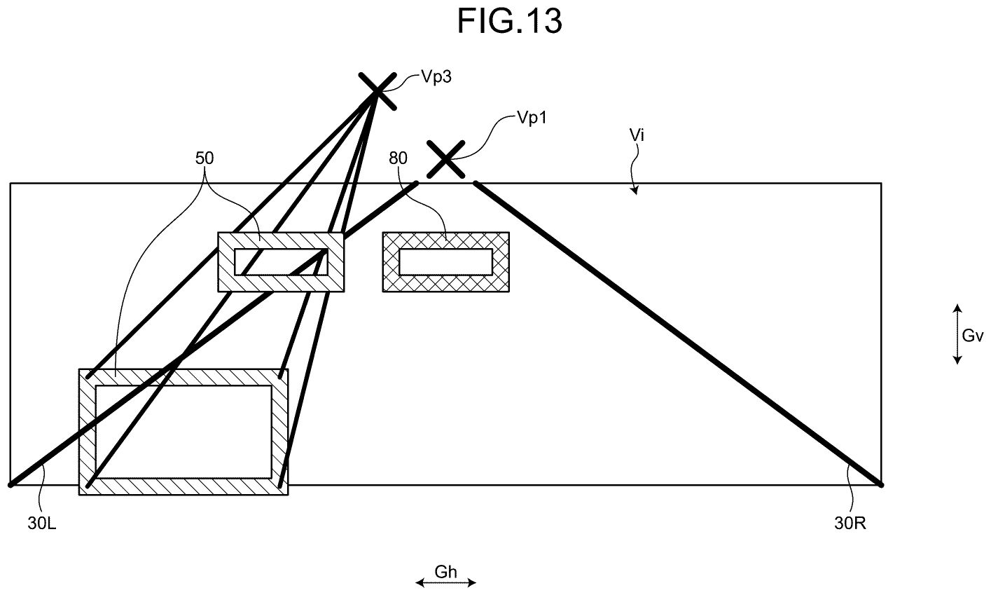

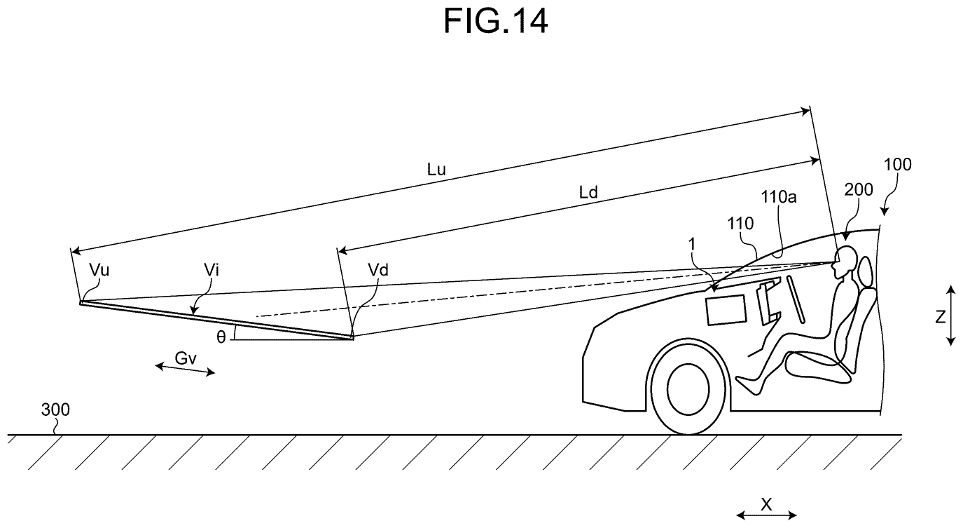

An embodiment will be described with reference to FIGS. 1 to 14. The present embodiment relates to a vehicle display device. FIG. 1 is a diagram of a vehicle equipped with a vehicle display device of an embodiment, FIG. 2 is a configuration diagram of a vehicle display device according to an embodiment, FIG. 3 is a diagram illustrating a first image and a second image according to an embodiment, FIG. 4 is a diagram illustrating a size of an image that is based on a first vanishing point, FIG. 5 is a diagram illustrating a scenery of a front side of a vehicle and a virtual image, FIGS. 6 and 7 are diagrams illustrating an example of a first image and a second image, FIG. 8 is a diagram illustrating a scenery of a front side of a vehicle and a virtual image, FIGS. 9 to 11 are diagrams illustrating another example of a first image and a second image, FIG. 12 is a diagram illustrating a content image to be displayed together with a guide image, FIG. 13 is a diagram illustrating an example of a third vanishing point, and FIG. 14 is a diagram illustrating a virtual image to be displayed with inclination.

FIGS. 1 and 2 illustrate an example of a vehicle display device 1 according to the present embodiment. The vehicle display device 1 of the present embodiment includes a display device 3 that displays an image to a driver 200. The display device 3 may be a meter device, may be a head-up display device, or may be another image display device.

The exemplified display device 3 displays a virtual image Vi to the driver 200 as described below. As illustrated in FIG. 2, the vehicle display device 1 displays the virtual image Vi to the driver 200 by projecting display light Lt of an image onto a reflection surface 110a of a vehicle 100 that is arranged in front of the driver 200. The reflection surface 110a of the present embodiment is a surface of a windshield 110 that is arranged on a vehicle interior side. Reflective coating may be applied to the reflection surface 110a.

As illustrated in FIG. 2, the vehicle display device 1 includes a casing 2, the display device 3, and a control unit 10. The casing 2 is arranged below the windshield 110 of the vehicle 100. The casing 2 is accommodated below a dashboard 120, for example. The display device 3 and the control unit 10 are accommodated in the casing 2.

The display device 3 includes an image display unit 4, a first mirror 5, and a second mirror 6. The image display unit 4 includes a liquid crystal display device such as, for example, a thin film transistor-liquid crystal display (TFT-LCD). The image display unit 4 has a display surface 4a on which an image is to be displayed. The display light Lt of the image is emitted from the display surface 4a. The image display unit 4 includes a backlight unit arranged on the back side of the display surface 4a, for example. In this case, the display light Lt is generated by light of the backlight unit.

The first mirror 5 reflects the display light Lt output from the image display unit 4, toward the second mirror 6. The first mirror 5 has a reflection surface 5r reflecting light. The shape of the exemplified reflection surface 5r is a convex aspheric surface. The shape of the reflection surface 5r is a shape correcting distortion of an image that occurs in the second mirror 6 or the windshield 110.

The second mirror 6 reflects the display light Lt entering from the side of the first mirror 5, toward the windshield 110. The casing 2 has a transparent cover 2a. The cover 2a faces an opening portion of the dashboard 120. The display light Lt passes through the cover 2a from the side of the second mirror 6 toward the side of the windshield 110. The reflection surface 110a of the windshield 110 reflects the display light Lt toward an eye point EP of the vehicle 100. The driver 200 views the virtual image Vi by the display light Lt. The position of the virtual image Vi viewed from the driver 200 exists in front of the windshield 110 in a vehicle front-back direction X.

The second mirror 6 of the present embodiment has a concave reflection surface 6r. The shape of the reflection surface 6r is an aspheric curved shape, and is a shape enlarging an image. The virtual image Vi has an image up-down direction Gv set in a case where the image is viewed from the driver 200.

The control unit 10 illustrated in FIG. 2 controls the display device 3. More specifically, the control unit 10 commands an image to be displayed on the display surface 4a, to the image display unit 4. The control unit 10 may generate an image to be displayed, and output this image to the image display unit 4. The control unit 10 controls the image display unit 4 based on a program stored in a memory or the like of the display device 3, for example.

The control unit 10 acquires various types of information regarding the vehicle 100, from a vehicle electric control unit (ECU) or the like that controls the vehicle 100. The information to be acquired by the control unit 10 includes, for example, a running speed of the vehicle 100, a shift position of the vehicle 100, information regarding a route guidance given by a navigation system, position information of the vehicle 100, information regarding a battery of the vehicle 100, and information regarding running control such as Adaptive Cruise Control (ACC).

As described below, an image to be displayed by the display device 3 includes a first image G1 and a second image G2. FIG. 3 illustrate an example of the first image G1 and the second image G2. Both of the first image G1 and the second image G2 of the present embodiment are displayed in a same display region GR. The shape of the display region GR is a rectangle, for example.

The first image G1 is an image simulating a scenery of the front side of the vehicle 100. The first image G1 is an image in which a depth that is based on a first vanishing point Vp1 is represented. The exemplified first vanishing point Vp1 is arranged on the upper side of the display region GR in the image up-down direction Gv. Nevertheless, the first vanishing point Vp1 may be set inside the display region GR.

The first image G1 includes a line image 30 illustrated in FIG. 3, for example. The line image 30 is an image representing the boundary of a lane on which the vehicle 100 runs. The line image 30 is a linear image extending toward the first vanishing point Vp1.

The line image 30 includes a left line image 30L and a right line image 30R. The left line image 30L is an image representing the left-side boundary of the lane on which the vehicle 100 runs. The left line image 30L is displayed on the left side of a vehicle image 20 being an image indicating the vehicle 100, in an image traverse direction Gh. The right line image 30R is an image representing the right-side boundary of the above-described lane. The right line image 30R is displayed on the right side of the vehicle image 20 in the image traverse direction Gh. An interval between the two line images 30L and 30R becomes narrower toward the upper side in the image up-down direction Gv.

The second image G2 is an image for information provision that is to be displayed in the same region as the display region GR of the first image G1. The second image G2 is an image in which a depth that is based on a second vanishing point Vp2 is represented. The second vanishing point Vp2 is a point different from the first vanishing point Vp1. The second image G2 includes an object image 70 being an image indicating a detected front object, for example.

The front object is a leading vehicle 400 detected by the ACC control, for example. In this case, the position and the size of the object image 70 vary depending on an inter-vehicular distance to the leading vehicle 400. In a case where the inter-vehicular distance increases, the object image 70 moves toward the rear side in a depth direction that is based on the second vanishing point Vp2, as indicated by an arrow AR1. In contrast to this, in a case where the inter-vehicular distance decreases, the object image 70 moves toward the near side in the depth direction that is based on the second vanishing point Vp2, as indicated by an arrow AR2.

The second vanishing point Vp2 is positioned on the upper side of the first vanishing point Vp1 in the image up-down direction Gv. In the vehicle display device 1 of the present embodiment, the size of the object image 70 changes based on the second vanishing point Vp2. With this configuration, it becomes possible to display the object image 70 in an appropriate size. In FIG. 4, an object image 70 supposed to be generated based on the first vanishing point Vp1 is indicated by a broken line. The object image 70 in FIG. 4 is smaller as compared with the object image 70 illustrated in FIG. 3. Further, if the object image 70 generated based on the first vanishing point Vp1 moves rearward toward the first vanishing point Vp1, the object image 70 becomes too small.

In contrast to this, the object image 70 generated based on the second vanishing point Vp2 can be displayed in an appropriate size in the display region GR. The position of the second vanishing point Vp2 is defined in such a manner that the visibility of the object image 70 can be ensured. In the object image 70 generated based on the second vanishing point Vp2, a change in the size of the object image 70 that is caused when the object image 70 moves along the depth direction becomes gradual. Thus, the vehicle display device 1 of the present embodiment can perform information display with a sense of depth while ensuring the visibility of the object image 70.

Further, an interval from the left line image 30L to the right line image 30R is made wide in such a manner that a user is less likely to have a feeling of strangeness to the object image 70. As illustrated in FIG. 3, the left line image 30L and the right line image 30R are arranged in such a manner as not to intersect with a locus L70 of the object image 70. The locus L70 is a straight line in the depth direction that is based on the second vanishing point Vp2, and is a locus of a lower end of the object image 70.

Because the line image 30 does not intersect with the locus L70, the user is unlikely to have a feeling of strangeness to a display size of the object image 70. Thus, the vehicle display device 1 of the present embodiment can represent a natural sense of depth while causing the two images G1 and G2 with different vanishing points to exist together in the same display region GR.

FIGS. 5 and 6 illustrate the virtual image Vi obtained when the vehicle 100 is about to catch up with the leading vehicle 400. As illustrated in FIG. 5, the virtual image Vi is displayed with being superimposed on a scenery Sc of the front side of the vehicle 100. As illustrated in FIG. 6, the first image G1 of the virtual image Vi includes the left line image 30L and the right line image 30R. The second image G2 of the virtual image Vi includes the vehicle image 20 and the object image 70. The virtual image Vi further includes a speed image 21, a setting value image 22, and a plurality of graphic images 60.

The speed image 21 is an image indicating a running speed of the vehicle 100, and is an image of a character indicating the speed, for example. The speed image 21 is always displayed in a case where the vehicle 100 is in a running mode, for example. The object image 70 is an image indicating the leading vehicle 400, and is an image simulating the shape of the vehicle. The object image 70 indicating the leading vehicle 400 is displayed during the execution of the ACC control, for example. The object image 70 is, for example, a bird's-eye image of the vehicle viewed from behind the vehicle.

As illustrated in FIG. 6, the vehicle image 20 and the object image 70 are drawn in perspective that is based on the second vanishing point Vp2. During the execution of the ACC control, the setting value image 22 and the graphic images 60 are further displayed. The setting value image 22 indicates a setting value of a running speed in the ACC control. In the following description, a setting value of a running speed in the ACC control will be simply referred to as a setting speed. The setting value image 22 is arranged on the upper side of the speed image 21 in the image up-down direction Gv. The setting value image 22 is displayed using smaller characters than those in the speed image 21. The speed image 21 and the setting value image 22 may be displayed adjacently in the depth direction that is based on the first vanishing point Vp1, or may be displayed adjacently in the depth direction that is based on the second vanishing point Vp2.

The graphic images 60 are images sterically representing a change in an inter-vehicular distance or the like in the ACC control. The shape of the graphic images 60 of the present embodiment is a rectangle. The graphic images 60 in FIG. 6 include an image 61, an image 62, and an image 63. The three graphic images 60 are displayed with being partially overlaid. Relative positions of the three graphic images 60 change in accordance with a target value of an inter-vehicular distance, or the like.

The three graphic images 60 are adjacently arranged along a line extending toward the first vanishing point Vp1, for example. The graphic images 60 may be arranged along a line extending toward the second vanishing point Vp2. The graphic images 60 are displayed between the vehicle image 20 and the object image 70. The image 61 is arranged at a position closest to the near side among the three graphic images 60. The image 63 is arranged at a position closest to the rear side among the three graphic images 60. The three graphic images 60 are arranged at equal intervals along the depth direction that is based on the vanishing point Vp1 or Vp2, for example.

Among the plurality of graphic images 60, the image 60 arranged at the position closest to the near side is larger than the other graphic images 60. Among the plurality of graphic images 60, the image 60 arranged at the position closest to the rear side is smaller than the other graphic images 60. Further, in a case where three or more graphic images 60 are displayed, the graphic images 60 become smaller toward the vanishing point Vp1 or Vp2 from the near side toward the rear side.

The image 61 of the present embodiment is displayed in such a manner that the vehicle image 20 overlaps a part of the image 61. That is, a part of the image 61 is hidden by the vehicle image 20. By such display, the driver 200 can easily recognize that a plurality of graphic images 60 indicates virtual objects or segments existing in front of the vehicle 100.

In the ACC control, in a case where the leading vehicle 400 is not detected, or in a case where an inter-vehicular distance from the leading vehicle 400 to the vehicle 100 is enough, control of causing the vehicle 100 to run at a setting speed is executed. The target speed in this case is equal to the setting speed. The vehicle ECU mounted on the vehicle 100 executes running control of causing the vehicle 100 to run at the target speed.

The vehicle ECU performs deceleration control in a case where an inter-vehicular distance between the vehicle 100 and the leading vehicle 400 decreases. The vehicle ECU decelerates the vehicle 100 in such a manner as to ensure a necessary inter-vehicular distance between the vehicle 100 and the leading vehicle 400, and causes the vehicle 100 to follow the leading vehicle 400.

FIG. 7 illustrates the virtual image Vi obtained when an inter-vehicular distance to the leading vehicle 400 has decreased from that in FIG. 6. The object image 70 gets closer to the vehicle image 20 than the position in FIG. 6 along the depth direction that is based on the second vanishing point Vp2. Further, the plurality of graphic images 60 gets closer to each other along the depth direction as compared with the state in FIG. 6. By the position and the size of the object image 70 changing based on the second vanishing point Vp2, it becomes possible to provide the driver 200 with information regarding a change in inter-vehicular distance while displaying the object image 70 in an appropriate size.

Next, another example of the second image G2 will be described with reference to FIGS. 8 to 12. FIG. 8 illustrates a virtual image Vi to be displayed when a route guidance is given to the driver 200. As illustrated in FIG. 8, the virtual image Vi is displayed with being superimposed on the scenery Sc of the front side of the vehicle 100. The exemplified virtual image Vi is displayed in such a manner as to overlap a road surface on the front side of the vehicle 100. In this case, the display device 3 projects the image onto a lower portion of the windshield 110.

As illustrated in FIG. 9, the virtual image Vi includes a first image G1 and a second image G2. The first image G1 includes at least one guide image 50. The guide image 50 is an image in which a depth that is based on a third vanishing point Vp3 different from the first vanishing point Vp1 is represented. The third vanishing point Vp3 is shifted from the first vanishing point Vp1 in the image traverse direction Gh.

The guide images 50 in FIG. 9 are displayed along the left line image 30L. In a case where the guide images 50 are displayed along the left line image 30L, the third vanishing point Vp3 is positioned on the left side of the first vanishing point Vp1 in the image traverse direction Gh. With this configuration, as described below, the visibility of the guide images 50 improves.

In a case where the virtual image Vi includes a plurality of guide images 50, the plurality of guide images 50 is displayed with being partially overlaid. The virtual image Vi in FIG. 9 includes an image 51, an image 52, and an image 53 as the guide images 50. The three images 51, 52, and 53 are displayed adjacently in the depth direction that is based on the third vanishing point Vp3, and with being partially overlaid. The exemplified guide images 50 are images guiding traveling directions at branch points existing ahead. The guide images 50 in FIG. 9 are images giving a route guidance to the driver 200 in such a manner as to turn left at the third branch point from the current position.

The image 51 is arranged at a position closest to the near side along the left line image 30L, among the three guide images 50. The image 53 is arranged at a position closest to the rear side along the left line image 30L, among the three guide images 50. The three guide images 50 are arranged at equal interval along the left line image 30L, for example.

The three images 51, 52, and 53 respectively have lower left corners 51c, 52c, and 53c. The corner 52c of the image 52 and the corner 53c of the image 53 are arranged along an imaginary line L1. The imaginary line L1 is a line segment connecting the corner 51c of the image 51 and the third vanishing point Vp3. The imaginary line L1 connecting the three corners 51c, 52c, and 53c extends in direction intersecting with the left line image 30L. The guide images 50 of the present embodiment are displayed in such a manner that an arrangement direction of the corners 51c, 52c, and 53c is less-recognizable by the user.

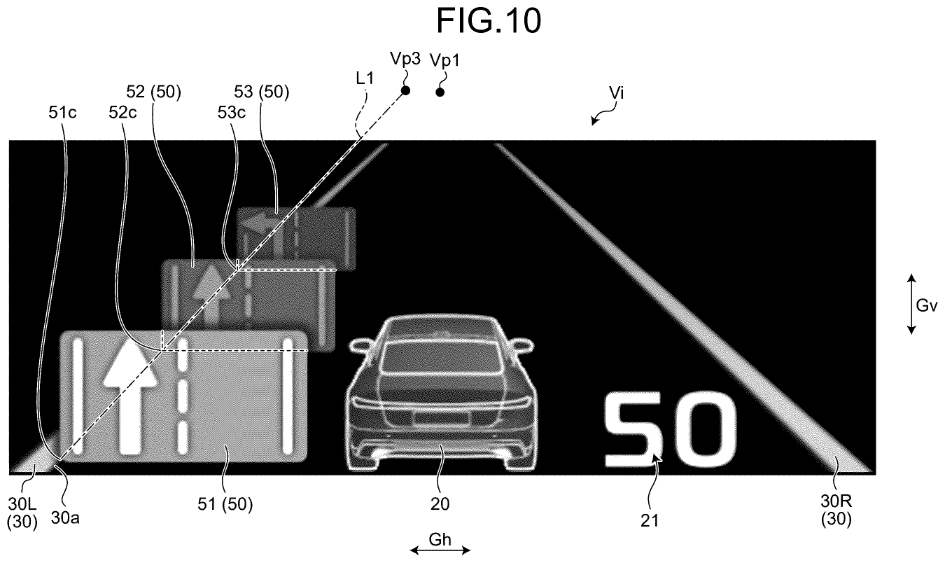

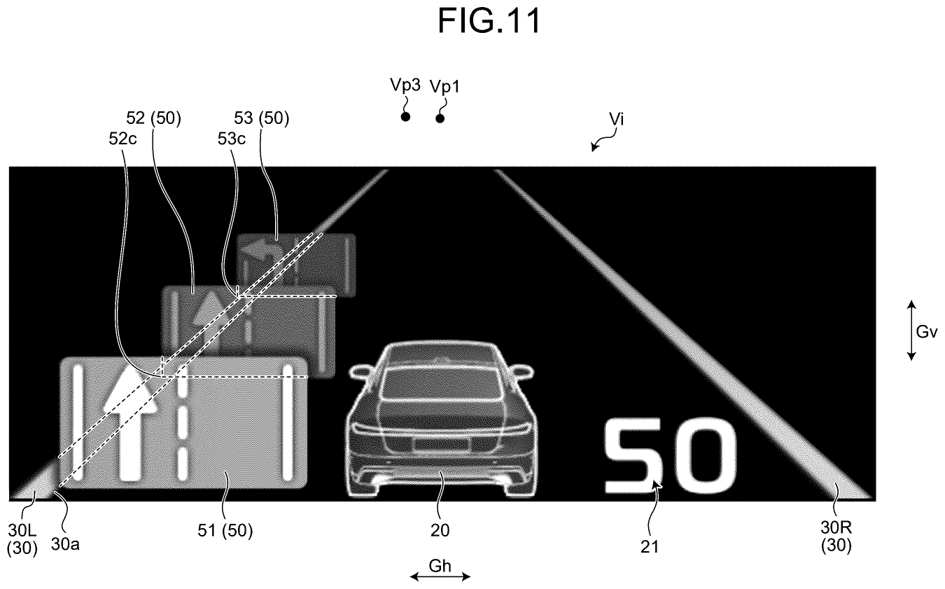

As illustrated in FIG. 10, the image 51 is arranged in such a manner that the lower left corner 51c is aligned with to a right-side rim 30a of the left line image 30L. The image 51 overlaps the image 52 in such a manner as to hide the lower left corner 52c of the image 52. The image 51 overlaps the corner 52c and the left line image 30L near the corner 52c in such a manner that a positional relationship between the corner 52c and the left line image 30L is less-recognizable. As illustrated in FIG. 11, the position of the corner 52c of the image 52 is shifted leftward from the right-side rim 30a of the left line image 30L. Nevertheless, because the corner 52c is hidden by the image 51, this shift is less noticeable, and less-recognizable by the user.

Similarly, the image 52 overlaps the image 53 in such a manner as to hide the lower left corner 53c of the image 53. The image 52 overlaps the corner 53c and the left line image 30L near the corner 53c in such a manner that a positional relationship between the corner 53c and the left line image 30L is less-recognizable. As illustrated in FIG. 11, the position of the corner 53c of the image 53 is shifted leftward from the left line image 30L. Nevertheless, because the corner 53c is hidden by the image 52, this shift is less noticeable, and less-recognizable by the user. According to the guide images 50 of the present embodiment, by the three images 51, 52, and 53 cloaking the left line image 30L, the existence of the third vanishing point Vp3 is less-noticeable by the user.

By the guide images 50 being generated based on the third vanishing point Vp3, the visibility of the guide images 50 improves. For example, in a case where the guide images 50 are generated based on the first vanishing point Vp1, the image 52 and the image 53 get closer to the center in the image traverse direction Gh, and narrow a space of the central part. In contrast to this, by the guide images 50 being arranged based on the third vanishing point Vp3, the space of the central part is effectively utilized.

For example, as illustrated in FIG. 12, in addition to the guide images 50, another content image 80 may be displayed. The content image 80 is an image for information provision. The content image 80 may be an image for route guidance, may be the object image 70, may be an image for heads-up or warning, or may be another image. The content image 80 is arranged at the central part in the image traverse direction Gh, for example. By the guide images 50 being arranged based on the third vanishing point Vp3, an appropriate clearance gap is formed between the guide images 50 and the content image 80. With this configuration, the visibility of the guide images 50 and the content image 80 is improved, respectively.

In addition, the third vanishing point Vp3 may be shifted from the first vanishing point Vp1 upward in the image up-down direction Gv in addition to being shifted in the image traverse direction Gh. FIG. 13 illustrates a third vanishing point Vp3 positioned on the left side of the first vanishing point Vp1 in the image traverse direction Gh, and positioned on the upper side of the first vanishing point Vp1 in the image up-down direction Gv. In this case, it is possible to increase the display size of the guide image 50 displayed on the rear side in the depth direction.

As described above, the vehicle display device 1 of the present embodiment includes the display device 3, and the control unit 10 that controls the display device 3. The display device 3 displays an image to the driver 200 of the vehicle 100. An image to be displayed by the display device 3 includes the first image G1 and the second image G2. The first image G1 is an image simulating the scenery of the front side of the vehicle 100, and is an image in which a depth that is based on the first vanishing point Vp1 is represented. The second image G2 is an image for information provision that is to be displayed in the same region as the display region GR of the first image G1. The second image G2 is an image in which a depth that is based on a vanishing point Vp2 or Vp3 different from the first vanishing point Vp1 is represented.

According to the vehicle display device 1 of the present embodiment, in the second image G2, a depth is represented based on the vanishing point Vp2 or Vp3 different from the first vanishing point Vp1. By the vanishing point Vp2 or Vp3 of the second image G2 being shifted from the first vanishing point Vp1, it becomes possible to improve the visibility of the image.

The second image G2 includes the object image 70 indicating a front object being an object detected on the front side of the vehicle 100, for example. The object image 70 is an image in which a depth that is based on the second vanishing point Vp2 is represented. The second vanishing point Vp2 is positioned on the upper side of the first vanishing point Vp1 in the image up-down direction Gv. In this case, the display size of the second image G2 is prevented from becoming too small.

The first image G1 includes the line image 30 being an image representing the boundary of a lane on which the vehicle 100 runs. The second image G2 may include the guide images 50 displayed along the line image 30. The guide image 50 is an image in which a depth that is based on a third vanishing point Vp3 different from the first vanishing point Vp1 is represented. The third vanishing point Vp3 is shifted from the first vanishing point Vp1 in the image traverse direction Gh. With this configuration, it becomes possible to provide an appropriate interval between a plurality of displayed images.

The line image 30 may include a left line image 30L and a right line image 30R. The left line image 30L is the line image 30 representing the left-side boundary of the lane. The right line image 30R is the line image 30 representing the right-side boundary of the lane. The third vanishing point Vp3 to be used in a case where the guide images 50 are displayed along the left line image 30L is positioned on the left side of the first vanishing point Vp1 in the image traverse direction Gh. The third vanishing point Vp3 to be used in a case where the guide images 50 are displayed along the right line image 30R is positioned on the right side of the first vanishing point Vp1 in the image traverse direction Gh. By such display, the guide images 50 are prevented from getting too closer to the center of the image.

### Modified Example of Embodiment

In addition, the vehicle display device 1 may be configured to display a virtual image Vi with inclination. For example, as illustrated in FIG. 14, the vehicle display device 1 may be configured to display an inclined virtual image Vi. The virtual image Vi in FIG. 14 is formed in such a manner that an upper part Vu is at a position farther from the driver 200 than a lower part Vd in the image up-down direction Gv. The virtual image Vi inclined in this manner may be realized by an optical system of the display device 3. The inclined virtual image Vi may be realized by inclining the display surface 4a of the image display unit 4, or may be realized by another means.

A component to be displayed in the guide image 50 is not limited to an arrow for route guidance. The guide image 50 may include character information. The shape of the object image 70 is not limited to the shape simulating a vehicle, and may be a cubic shape, for example. The display position of the virtual image Vi is not limited to the position exemplified in the embodiment. For example, the virtual image Vi may be displayed with being superimposed on a subject of attention or the like that exists in front of the vehicle 100. The subject of attention may be, for example, another vehicle such as the leading vehicle 400, or a pedestrian, or may be another target object. The reflection surface that reflects the display light Lt toward the driver 200 is not limited to the surface of the windshield 110. The reflection surface may be a reflection surface of a combiner, for example, or may be a surface of another reflection member.

The first image G1 is not limited to the line image 30. An image simulating a scenery of a front side of the vehicle 100 may be an image simulating an architectural structure such as a building, may be an image simulating a structural object such as a guardrail or a road shoulder, or may be another image.

The guide images 50 may be displayed along the right line image 30R. The third vanishing point Vp3 to be used in a case where the guide images 50 are displayed along the right line image 30R is arranged on the right side of the first vanishing point Vp1 in the image traverse direction Gh.

The display device 3 may be a device that displays a real image of the first image G1 and a real image of the second image G2 to a driver. In this case, the display device 3 may be a meter device, for example. The display device 3 that displays real images is arranged in front of the driver 200 in such a manner that the display surface 4a is viewed from the driver, for example.

The matters disclosed in the above-described embodiment and modified examples can be executed while being appropriately combined.

A vehicle display device according to the present embodiment includes a display device configured to display an image to a driver of a vehicle, and a control unit configured to control the display device, in which an image to be displayed by the display device includes a first image and a second image. The first image is an image simulating a scenery of a front side of the vehicle, and is an image in which a depth that is based on a first vanishing point is represented, and the second image is an image for information provision that is to be displayed in a same region as a display region of the first image, and is an image in which a depth that is based on a vanishing point different from the first vanishing point is represented. According to the vehicle display device according to the present embodiment, there can be achieved the effect that an image with a sense of depth can be displayed while suppressing a degradation in visibility, by shifting the position of a vanishing point.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle display device comprising:
a display device configured to display an image to a driver of a vehicle; and
a control unit configured to control the display device,
wherein an image to be displayed by the display device includes a first image and a second image,
wherein the first image is an image simulating a scenery of a front side of the vehicle, and is an image in which a depth that is based on a first vanishing point is represented, and
wherein the second image is an image for information provision that is to be displayed in a same region as a display region of the first image, and is an image in which a depth that is based on a vanishing point different from the first vanishing point is represented.

2. The vehicle display device according to claim 1,
wherein the second image includes an image indicating a front object being an object detected on a front side of the vehicle,
wherein the image indicating the front object is an image in which a depth that is based on a second vanishing point is represented, and
wherein the second vanishing point is positioned on an upper side of the first vanishing point in an image up-down direction.

3. The vehicle display device according to claim 1,
wherein the first image includes a line image being an image representing a boundary of a lane on which the vehicle runs,
wherein the second image includes a guide image displayed along the line image,
wherein the guide image is an image in which a depth that is based on a third vanishing point different from the first vanishing point is represented, and
wherein the third vanishing point is shifted from the first vanishing point in an image traverse direction.

4. The vehicle display device according to claim 3,
wherein the line image includes a left line image representing a left-side boundary of the lane, and a right line image representing a right-side boundary of the lane,
wherein the third vanishing point to be used in a case where the guide image is displayed along the left line image is positioned on a left side of the first vanishing point in the image traverse direction, and
wherein the third vanishing point to be used in a case where the guide image is displayed along the right line image is positioned on a right side of the first vanishing point in the image traverse direction.
